(19) United States
(12) Patent Application Publication
(10) Pub. No.: US 2021/0390389 A1
(43) Pub. Date: Dec. 16, 2021

(54) DATA EXCHANGE FOR MACHINE LEARNING SYSTEM AND METHOD

(71) Applicant: Michael R. Limotta, Solvang, CA (US)

(72) Inventor: Michael R. Limotta, Solvang, CA (US)

(21) Appl. No.: 16/902,232

(22) Filed: Jun. 15, 2020

(51) Int. Cl. G06N 3/08; G06F 9/46; H04L 9/06; H04L 9/32

(52) U.S. Cl. CPC G06N 3/08; G06F 9/466; H04L 2209/38; H04L 9/3213; H04L 9/0643

(57) ABSTRACT

A data exchange system includes a first computer processor environment configured to accept a dataset from a client user. The first computer processor environment includes an exchange interface for receiving input from a user. The data exchange system also includes a second computer processor environment configured to run at least partially trained neural network software that has been trained to perform scoring of the dataset. The second computer processor environment is configured to receive the dataset from the first computer processor environment. The data exchange system further includes a third computer processor environment configured to receive the dataset. The third computer processor environment provides user useable output through a GUI running on the third computer processor environment.

### BACKGROUND

Neural Networks and other machine learning paradigms require large datasets for training the neural networks or otherwise learning nonlinear mappings of data. Conventionally a neural network receives large numbers of known input and output pairs. When the network is presented with an input, an output is generated and compared with the desired output. The error between the generated output and the desired output is used to train the network in backpropagation learning or other learning methodologies. To improve the performance of neural networks, especially for very complex relationships between input and output, a large number of input output pairs are required. The more pairs that are trained on, typically improves the accuracy of the input output relationship. Most companies which require such large datasets neither have the time nor the resources to create them through testing and data collection rather they may rely on data that already exists. Therefore, there is a need for large datasets to train such networks and machine learning paradigms.

Large datasets may be publicly available in some circumstances and for some mappings however, these datasets may be quite limited in scope or may not be engineering data that is needed, such as aerospace data, because there are no incentives for private industries to share such datasets. Conventionally, there is no public exchange for datasets, most datasets that are made available for use are simply shared for nothing apparent in exchange. Another issue with publicly available datasets is that there is no anonymization of the data which is a disincentive for sharing.

Accordingly, there is a need for a system and method for a data exchange where large datasets are able to be shared between parties and incentives may be provided to providers of datasets. Further, there is a need for a data exchange where shared datasets which are made available may be anonymized as to their source. Further still, there is a need for methods of scoring such datasets as to their relevance and value and maintaining their validity.

### SUMMARY

An illustrative embodiment relates to a data exchange system. The data exchange system includes a first computer processor environment configured to accept a dataset from a client user. The first computer processor environment includes an exchange interface for receiving input from a user. The data exchange system also includes a second computer processor environment configured to run at least partially trained neural network software that has been trained to perform scoring of the dataset. The second computer processor environment is configured to receive the dataset from the first computer processor environment. The data exchange system further includes a third computer processor environment configured to receive the dataset. The third computer processor environment provides user useable output through a GUI running on the third computer processor environment.

Another illustrative embodiment relates to a method for a data exchange that includes accepting a dataset from a client user by a first computer processor environment. The first computer processor environment includes an exchange interface for receiving input from a user. The method also includes running at least partially trained neural network software, on a second computer processor environment that has been trained to perform scoring of the dataset. The second computer processor environment receives the dataset from the first computer processor environment. Further still, the method includes receiving the dataset by the third computer processor environment and providing user useable output through a GUI running on the third computer processor environment.

Yet another illustrative embodiment relates to a data exchange system that, includes a means for accepting a dataset from a client user by a first computer processor environment. The first computer processor environment includes an exchange interface for receiving input from a user. The system also includes a means for running at least partially trained neural network software, on a second computer processor environment that has been trained to perform scoring of the dataset. The second computer processor environment receives the dataset from the first computer processor environment. Further still, the system includes a means for receiving the dataset by the third computer processor environment and a means for providing user useable output through a GUI running on the third computer processor environment.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is an illustrative embodiment of a system for

[symbol]

FIG. 2 is an illustrative embodiment of a flow diagram for

[symbol]

### The use of the same symbols in different drawings typically indicates similar or identical items unless context dictates otherwise.

### DETAILED DESCRIPTION

In accordance with illustrative embodiments a data exchange facilitates companies in gaining the benefits of AI. A data exchange for engineering data may also be applied for different, and less complex, applications. Such a data exchange would be beneficial to encourage more openness to data sharing, while respecting the value and privacy of certain datasets.

An artificial neural network (ANN) is a system that, due to its topological structure, can adaptively learn nonlinear mappings from input to output space when the network has a large database of prior examples from which to draw. In some sense, an ANN simulates human functions such as learning from experience, generalizing from previous to new data, and abstracting essential characteristics from inputs containing irrelevant data. Using an ANN for propulsion system modelling, without the need for significant physical modeling or insight, may be highly advantageous because in an ANN, the source terms are highly nonlinear functions of the input parameters. Hence, linear interpolation is not an appropriate approach to their modeling, unless each parameter of the data set is divided into an enormous number of small increments.

The basic architecture of a neural network includes layers of interconnected processing units called neurons (comparable to the dendrites in the biological neuron) that transform an input vector [c1, c2, . . . , cM]T into an output vector[a1n, a2n, . . . , aSn]T . Neurons without predecessors are called input neurons and constitute the input layer. All other neurons are called computational units because they are developed from the input layer. A nonempty subset of the computational units is specified as the output units. All computational units that are not output neurons are called hidden neurons.

The universal approximation theorem states that a neural network with one hidden layer, utilizing a sigmoid transfer function, is able to approximate any continuous function f:RM→R S2 (where M and S2 are dimensions of the function domain and range, respectively) in any domain, with a given accuracy based, in part, on the amount of training data. Features of the input data are extracted in the hidden layer with a hyperbolic tangent transfer function and in the output layer with a purely linear transfer function. Based on the theorem and thanks to the topological structure of the neural network, one can generate complex data dependencies without performing time-consuming computations. However, any neural network application depends on the training or learning algorithm. The learning algorithm is the repeated process of adjusting weights to minimize the network errors. These errors are defined by e=t−a, where t is the desired network output vector and a=a(c, [W]) is the actual network output vector, a function of the input data and network weights. This weight adjustment is repeated for many training samples and is stopped when the errors reach a sufficiently low level.

The majority of neural network applications are based on the backpropagation algorithm. The term backpropagation refers to the process by which derivatives of the network error, with respect to network weights and biases, are calculated, from the last layer of the network to the first. The Levenberg-Marquardt backpropagation scheme is one such technique used to optimize neural network weights however any other applicable method may be used without departing from the scope of the invention.

In order to gain advantage of the use of ANNs, large datasets of training data must be acquired. Public datasets are available such as Datafloq and Qlik Datamarket. These are public datasets sources and therefore provide no incentive to for participants to give private information to the datasets. Typically, these public datasets have no data relating to certain areas, for example but without limit, datasets in the aerospace field or even in the engineering field. Such public datasets also do not encourage an exchange of data in any way. The data being provided is simply being shared publicly with nothing in return. Further still, these public datasets often take no steps to anonymize the data being publicly shared.

Illustrative embodiments herein relate to a managed exchange for data that may be used in machine learning applications. The primary purpose behind the managed exchange is to benefit the engineering industry and encourage more technological growth within it. The managed data exchange facilitates access for new organizations (startups) that might not have contacts/relationships to access large datasets. Data providers may be incentivized to share their datasets and will be able to realize the benefits of AI and machine learning for their specific application more quickly having been a member of the data exchange system and having access to datasets from other sources.

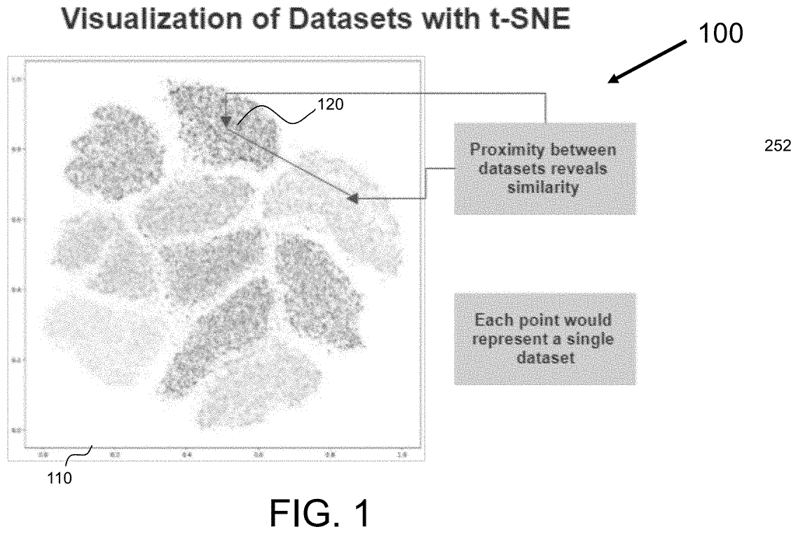

Referring now to FIG. 1, a browsing interface 100 visualizes the data exchange as a T-distributed stochastic neighbor embedding (t-SNE) plot 110 or any other dataset visualization tool (such as but not limited to any feature projection with dimensionality reduction techniques like Principal Component Analysis (PCA), and other autoencoders). Each point 120 on the t-SNE represents an entire dataset. This assists users that wish to find similar datasets by closeness on the t-SNE, whereas datasets farther from each other are dissimilar. In some instances, it may be difficult to ascertain how to categorize a specific dataset. In such instances, unsupervised learning methods, such as but not limited to clustering methods, may be applied to categorize datasets if they are inadequately labeled by their respective owners.

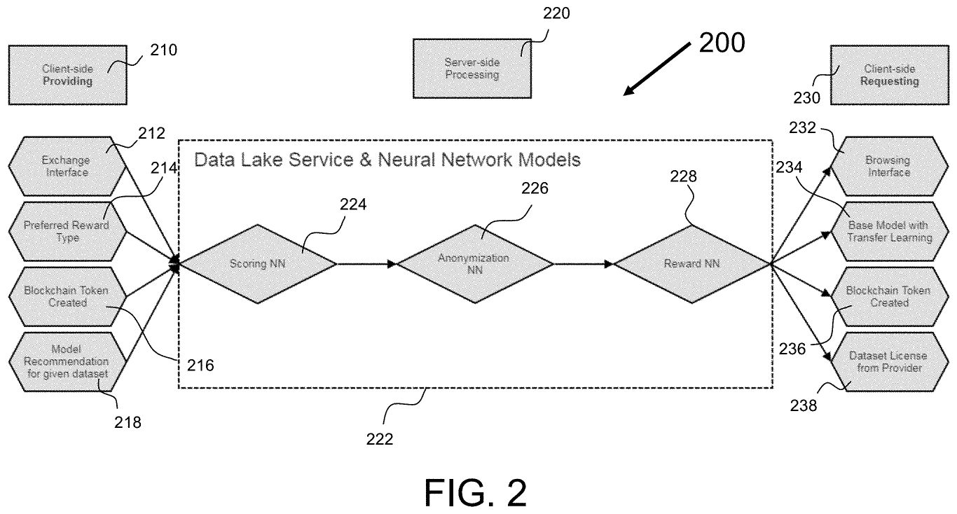

Referring now to FIG. 2, a flow diagram 200 is depicted for the managed data exchange. Three different primary parts of the flow include a client-side data providing portion 210, a server-side processing portion 220, and a client-side requesting portion 230. As a client is providing datasets to exchange system 200, an exchange interface 212 may be presented to the dataset provider where the provider chooses or is presented with a preferred reward type 214. As the provider provides the dataset to the system, a blockchain token is created 216 thereby creating a logged record of the dataset. The distributed blockchain ledger is used to verify all transactions having to do with each dataset, for example, the following are transactions which may be verified that include but are not limited to (1) Dataset Input to System by Provider, (2) User Requested Dataset from Provider, (3) User Approved for Dataset by Provider, and (4) Dataset licensed to User by System (or Provider if on P2P network). A model recommendation 218 is automatically generated or manually provided from the provider for the given dataset.

Because these datasets are numerous and large, automated systems need to be implemented to handle them. These automated systems may include but are not limited to the Data Lake Service and Neural Network Models 222. In accordance with illustrative embodiments, Data Lake Service and Neural Network Models 222, which may be hosted in cloud environments e.g., includes algorithms for parsing the data and neural network algorithms. The datasets may be encrypted when uploaded. In some instances, private keys may be owned by the uploader and by the hosting service. The neural network algorithms include but are not limited to a scoring neural network 224 (providing a scoring based on for example the 4Vs of big data—volume, variety, velocity, and veracity), an anonymization neural network 226 (configured to remove trade secret or confidential information), and a reward neural network 228 (configured to determine a reward available to the provider). Any applicable type of neural network may be applied for any of these nbeural network instances including but not limited to perceptron-based feed forward networks of varied architectures, recurrent neural networks, deep feed forward networks, deep convolutional neural networks, etc.

On the client-side requesting portion 230, a client may access the datasets available through a browsing interface 232 where dataset selections may be made. A Base model with transfer learning 234 is provided to help with neural network training for the future neural networks being constructed. When the client requests a dataset, a blockchain token is created 236, thereby logging the use of the dataset in the blockchain ledger and providing access to the dataset through the token. In accordance with an illustrative embodiment, for client access to the dataset, a license to the dataset may be granted from the provider. The license may be granted freely or in exchange for any type of consideration.

In accordance with an illustrative embodiment, the following constitutes an example process:
1. A provider uploads a dataset to the system (structured, or semi-structured is specified).
2. The system parses the dataset, evaluates, and scores it based on the category. For example, a Scoring NN trained on holistic scoring may be used.
3. The system removes any trade secret or confidential information (as labeled by the provider). For example, an Anonymization NN may be used to identify and segment certain fields.
4. Another user (separate from Provider) may request the data and is provided a license to use it.

In accordance with illustrative embodiments, there may be an incentive, or reward to drive users to provide datasets to the exchange. The incentives may be monetary, service-based, or a simple exchange of data. In a Monetary Reward situation, the system provides cash to the provider based on a calculated value of the data (these value metrics may be determined by the Scoring Neural Network). In a Service-Based situation, the System provides training time and inference time for the dataset based on requirements stated by the providing user. In a Simple Exchange situation, the providing user may select a dataset that they wish to obtain and are provided a license when uploading their own unique dataset.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A data exchange system, comprising:
a first computer processor environment configured to accept a dataset from a client user, the first computer processor environment including an exchange interface for receiving input from a user;
a second computer processor environment configured to run at least partially trained neural network software that has been trained to perform scoring of the dataset, the second computer processor environment configured to receive the dataset from the first computer processor environment; and
a third computer processor environment configured to receive the dataset, the third computer processor environment providing user useable output through a GUI configured to run on the third computer processor environment.

2. The data exchange system of claim 1, wherein the first and third computer processor environments are configured to run on the same computer.

3. The data exchange system of claim 1, wherein the first, second, and third computer processor environments are configured to run on the same computer.

4. The data exchange system of claim 1, wherein the second computer processor environment are configured to run one or more of more than one configuration of neural network software.

5. The data exchange system of claim 1, wherein the neural network software comprises a multilayer perceptron network.

6. The data exchange system of claim 1, further comprising:
a fourth computer environment configured to run at least partially trained neural network software that has been trained to perform anonymization of the dataset.

7. The launch window prediction system of claim 1, further comprising:
a fourth computer environment configured to run at least partially trained neural network software that has been trained to perform reward analysis.

8. The data exchange system of claim 1, further comprising:
a fourth computer environment configured to run at least partially trained neural network software that has been trained to perform anonymization of the dataset; and
a fifth computer environment configured to run at least partially trained neural network software that has been trained to perform reward analysis.

9. The data exchange system of claim 1, wherein the GUI configured to run the third computer processor environment includes a feature projection with dimensionality reduction plot.

10. The data exchange system of claim 1, wherein the GUI configured to run on the third computer processor environment includes a dataset visualization tool.

11. The data exchange system of claim 1, wherein the dataset is logged in a blockchain ledger.

12. The data exchange system of claim 1, wherein the dataset is logged in a distributed blockchain ledger.

13. The data exchange system of claim 1, wherein the third computer processor environment is configured to provide a dataset license from a dataset provider.

14. The data exchange system of claim 1, wherein the third computer processor environment is configured to provide a dataset license from a dataset provider.

15. The data exchange system of claim 1, wherein the third computer processor environment is configured to provide a base model with transfer learning for a neural network, based on the dataset.

16. The data exchange system of claim 11, wherein the third computer processor environment is configured to provide a blockchain token for access to the dataset.

17. The data exchange system of claim 11, wherein the third computer processor environment is configured to provide a blockchain token for access to the dataset.

18. The data exchange system of claim 11, wherein the third computer processor environment is configured to record a transaction with the dataset in the blockchain ledger.

19. A method for a data exchange, comprising:
accepting a dataset from a client user by a first computer processor environment, the first computer processor environment including an exchange interface for receiving input from a user;
running at least partially trained neural network software, on a second computer processor environment that has been trained to perform scoring of the dataset, the second computer processor environment receiving the dataset from the first computer processor environment;
receiving the dataset by the third computer processor environment; and
providing user useable output through a GUI running on the third computer processor environment.

20. A data exchange system, comprising:
a means for accepting a dataset from a client user by a first computer processor environment, the first computer processor environment including an exchange interface for receiving input from a user;
a means for running at least partially trained neural network software, on a second computer processor environment that has been trained to perform scoring of the dataset, the second computer processor environment receiving the dataset from the first computer processor environment;
a means for receiving the dataset fly the third computer processor environment; and
a means for providing user useable output through a GUI running on the third computer processor environment.
